(19) United States
(12) Patent Application Publication
(10) Pub. No.: US 2004/0221181 A1
(43) Pub. Date: Nov. 4, 2004

(54) Computer power control device

(76) Inventor: Tsung-I Yu, Taipei (TW)

Correspondence Address: BACON & THOMAS, PLLC, 625 SLATERS LANE, FOURTH FLOOR, ALEXANDRIA, VA, 22314

(21) Appl. No.: 10/425,838

(22) Filed: Apr. 30, 2003

(51) Int. Cl. G06F 1/26

(52) U.S. Cl. 713/300

(57) ABSTRACT

A computer power control device comprises a jacket, on which a number of sockets in parallel connections are installed. One of the sockets is isolated from others to be the primary socket, which is the power outlet for a computer. The secondary sockets, sockets other than the primary socket, are power outlets for peripheral devices associated with the computer. The primary socket can be switched on/off by a power switch, whereas the secondary sockets are switched on/off by a signal sent by the computer to a universal serial bus (USB) hub on the jacket. As the computer is turned on/off, the power outlets for the peripheral devices are switched on/off automatically. This mechanism can not only save time and electricity but also enhance safety.

### BACKGROUND OF THE INVENTION

(a) Field of the Invention

The present invention relates to a computer power control device, and more particularly to a computer power control device that automatically switches on/off power outlets for peripheral devices following the turning on/off of a computer.

(b) Description of the Prior Art

The conventional power socket sets dealing with the needs of increasing the number of power sockets or extending the length of a power cord include an extended power cord and a jacket with a plurality of sockets. When used with a computer system that may include a computer, a monitor, a printer, a speaker pair, a scanner, a modem, etc., a conventional power socket set provides each peripheral device with an independent power outlet. Those power outlets are controlled by a single power switch on the jacket or have their respective switches. As shown in FIG. 1, a conventional power socket set includes a plug A, five sockets B in parallel connections, and a simple control circuit C. A main switch SW1 simultaneously controls the power state of all sockets. When used with a computer system, we usually do not switch off the main switch SW1 after we shutdown a computer. Instead, we turn off the switches of the peripheral devices one by one, which is inconvenient to operate. It is common that some of the peripheral devices are not switched off after the shutdown of the computer. Therefore, they continue to consume electricity, which is a waste of energy and may even cause overheat of associated circuits. In some occasions, the power socket set and the power cord are hidden for decorative reasons, which makes it even more difficult to reach the main power switch.

### SUMMARY OF THE INVENTION

Accordingly, the primary object of the present invention is to provide a computer power control device that can switch on/off the peripheral devices associated with a computer automatically after the computer is turned on/off.

To achieve above object, the computer power control device according to the present invention utilizes a plurality of sockets in parallel connections and isolates one of them as a primary socket, which serves as a power outlet for a computer. At the same time, a universal serial bus (USB) cable interconnects the computer and the computer power control device. As the computer is turned on/off, a signal is sent to the universal serial bus (USB) hub of the computer power control device through the signal cable. The signal activates a control circuit associated with the universal serial bus (USB) hub, which in turn disconnects the sockets other than the primary socket from an internal power inlet in the computer power control device. Instead, a mechanical power switch controls the connection of the primary socket to the power inlet. It is a further advantage that the computer power control device according to the present invention is reliable and safe to use.

The various objects and advantages of the present invention will be more readily understood from the following detailed description when read in conjunction with the appended drawing.

### BRIEF DESCRIPTION OF THE DRAWINGS

FIG. 1 is the circuit diagram of a computer power control device of the prior art.

FIG. 2 is an exploded view of a computer power control device according to the present invention.

FIG. 3 is a perspective view of a computer power control device according to the present invention, with power outlets used in Germany.

FIG. 4 is the circuit diagram of a computer power control device according to the present invention, with an RJ11 connector.

FIG. 5 is the circuit diagram of a computer power control device according to the present invention, with an RJ45 connector.

FIG. 6 is a perspective view of a computer power control device according to the present invention, with power outlets used in France.

FIG. 7 is a perspective view of a computer power control device according to the present invention, with power outlets used in Italy.

FIG. 8 is a perspective view of a computer power control device according to the present invention, with power outlets used in England.

FIG. 9 is a perspective view of a computer power control device according to the present invention, with power outlets used in the United States.

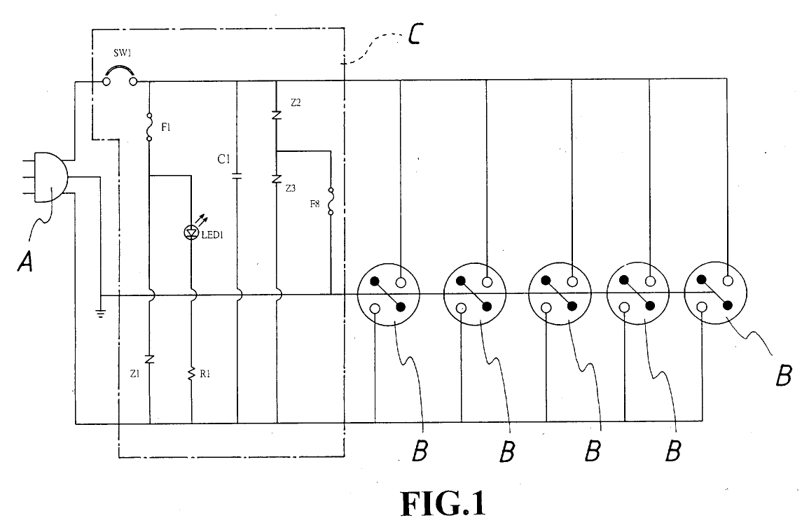

### DETAILED DESCRIPTION OF THE PREFERRED EMBODIMENTS

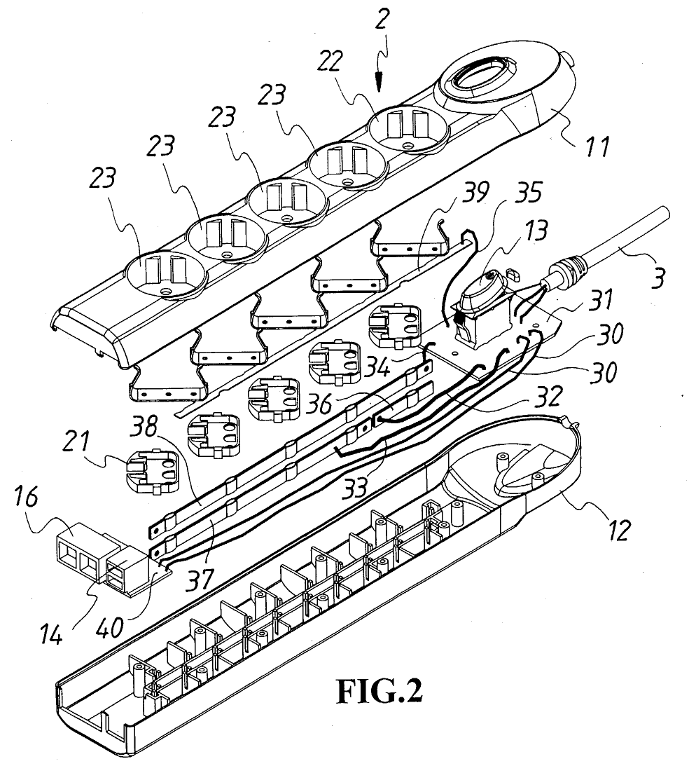

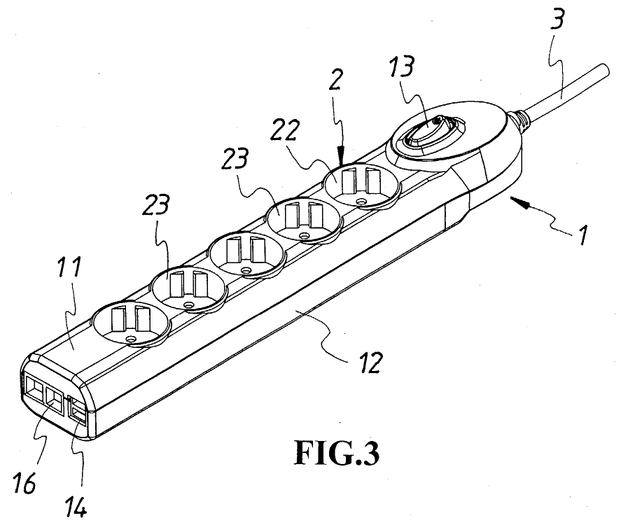

As shown in FIGS. 2 and 3, a computer power control device according to the present invention includes a jacket 1, which is composed of an upper portion 11 and a lower portion 12 and has a predetermined number of sockets 2 in parallel connections thereon. A safety cover 21 having five holes that fits to a power outlet in a particular geographic region is seated in each socket, as shown in FIG. 2. A power cord 3 includes two terminals, one having a plug designed to fit an external power outlet in a particular geographic region and the other being connected to a primary circuit board 31 within the jacket 1. Four electric wires 32, 33, 34, 35 interconnect the primary circuit board 31 and respectively a short N-shaped copper electrode plate 36, a long N-shaped copper electrode plate 37, a L-shaped copper electrode plate 38, and a grounding copper electrode plate 39. These copper electrode plates extend through the sockets 2 underneath the safety covers 21 and provide the holes thereon with electric connections. A pair of electric wires 30 interconnects the primary circuit board 31 and a secondary circuit board 40. The primary circuit board 31, the secondary circuit board 40, the copper electrode plates 36, 37, 38, 39, and the electric wires 30, 32, 33, 34, 35 are fixed in their respective positions in the jacket 1. The connections between the circuits, the electric wires, and the electrode plates define a primary socket 22 and a number of secondary sockets 23. The primary socket 22 serves as a power outlet for a computer. The secondary sockets 23 serve as power outlets for peripheral devices of a computer. The peripheral devices include monitors, printers, speakers, scanners, modems, etc. Though the number of secondary sockets 23 shown in FIG. 2 or 3 is four, it can go up to 10, depending on necessity.

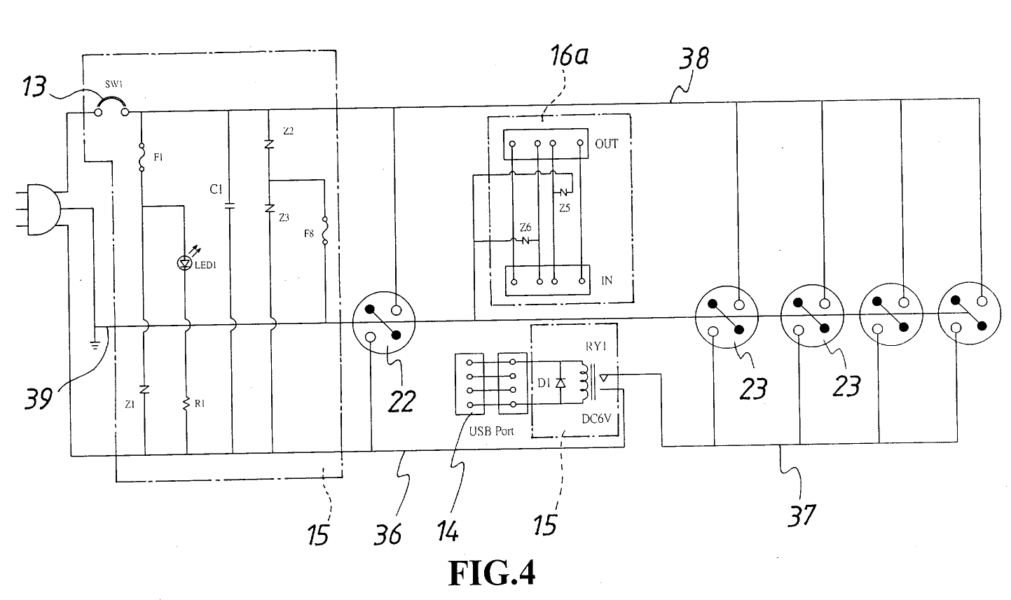

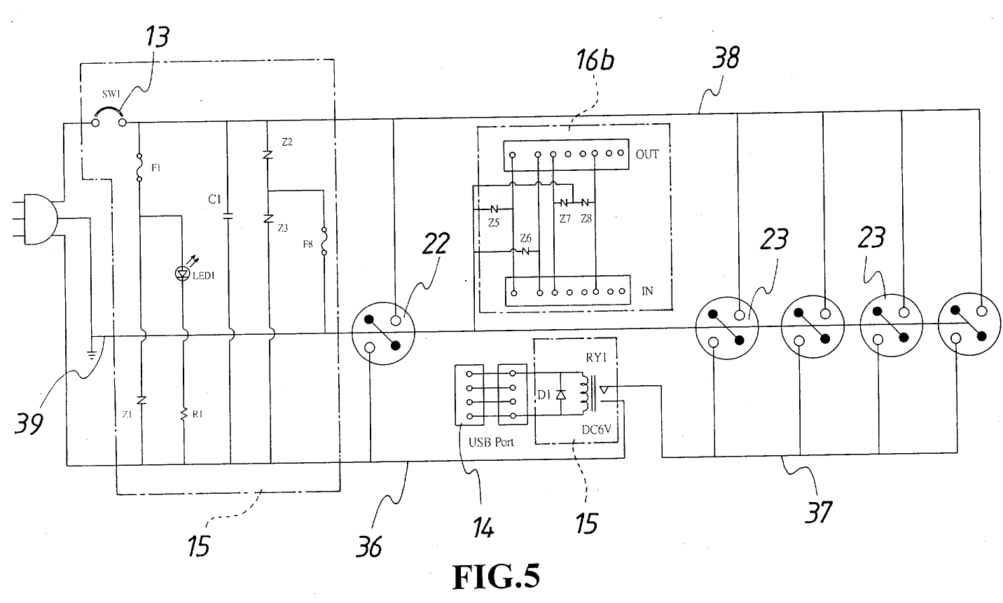

The jacket 1 of the computer power control device further comprises a power switch 13 and a universal serial bus (USB) hub 14. The power switch 13 is located on the upper portion 11 of the jacket 1 and connected to the primary circuit board 31. The universal serial bus (USB) hub 14 is located on the end face of the jacket 1 and connected to the secondary circuit board 40. The universal serial bus (USB) hub 14 is for receiving a terminal of a universal serial bus (USB) signal cable. The other terminal of the signal cable is connected to the universal serial bus (USB) port of the computer. (The computer and the universal serial bus (USB) signal cable are not shown in the figures.) When the computer is turned off, a signal is sent simultaneously to a control circuit 15 in the jacket 1 via the universal serial bus (USB) signal cable; the control circuit 15 is embedded on the primary circuit board 31, as shown in FIGS. 4 and 5. The control circuit 15 then disconnects all the secondary sockets 23 from an internal power inlet within the jacket 1, while maintains the connection of the primary socket 22 to the power inlet. Only the power switch 13 can switch off the power inlet of the primary socket 22. When the computer is turned on, a signal is sent through the universal serial bus (USB) signal cable to the control circuit 15 to switch the secondary sockets 23 back to the power inlet.

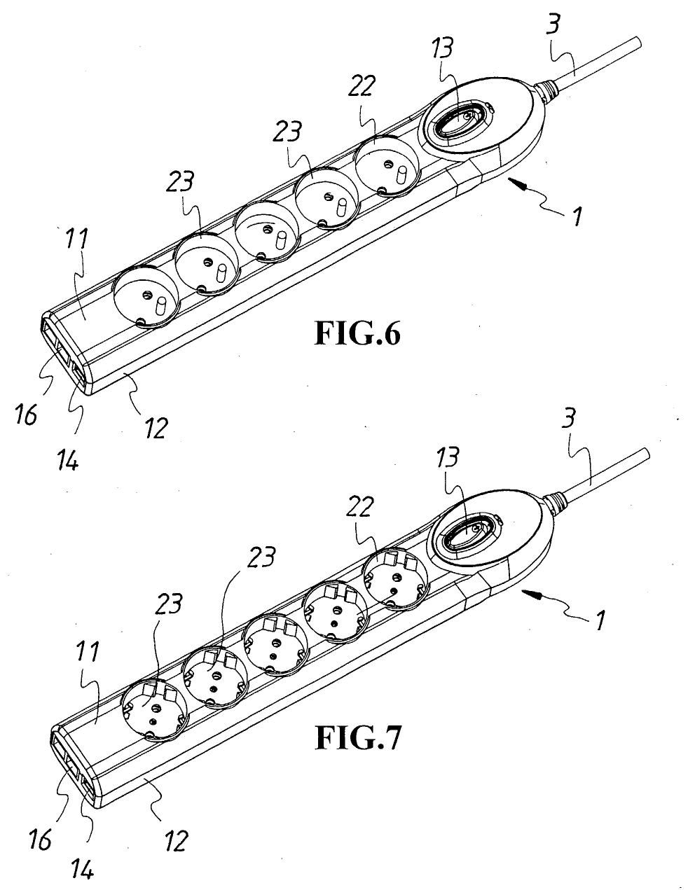

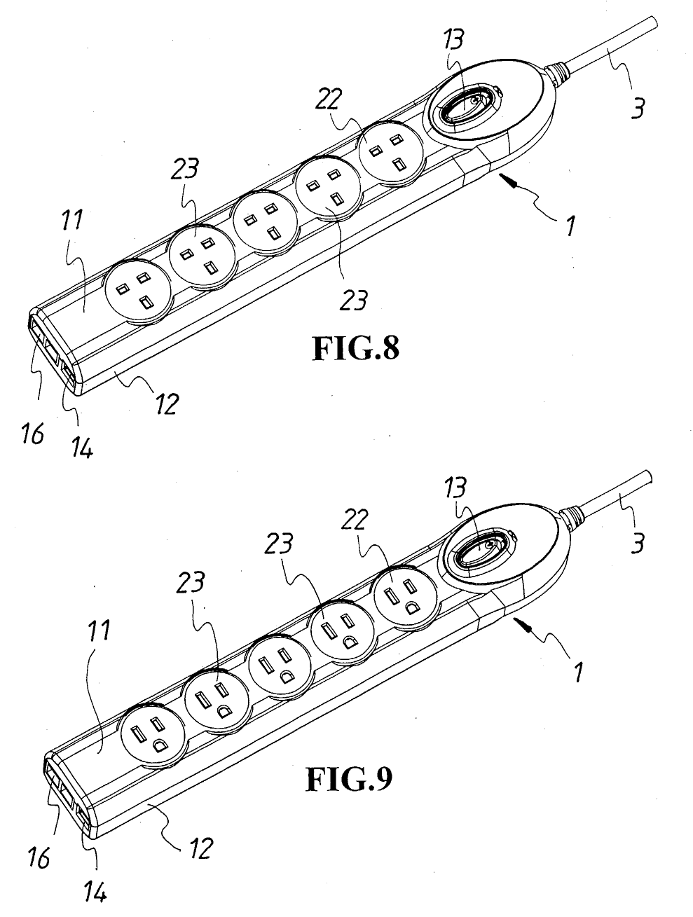

In addition to the universal serial bus (USB) hub 14, an RJ11 or RJ45 connector 16 can be installed on the jacket 1. The connector 16 is connected to the secondary circuit board 40 and is preferably located adjacent to the universal serial bus (USB) hub 14 on the same end face of the jacket 1. The RJ11 connector 16, its circuit 16a and its connection to the control circuit 15 are shown in FIG. 4. The RJ45 connector 16, its circuit 16b and its connection to the control circuit 15 are shown in FIG. 5. FIG. 6 shows the outlook of the computer power control device with power sockets used in France. FIG. 7 shows the outlook of the computer power control device with power sockets used in Italy. FIG. 8 shows the outlook of the computer power control device with power sockets used in England. FIG. 9 shows the outlook of the computer power control device with power sockets used in the United States and Taiwan.

To summarize, a computer power control device according to the present invention utilizes a plurality of sockets in parallel connections and isolates one of them as a primary socket, which serves as a power outlet for a computer. At the same time, a universal serial bus (USB) cable interconnects the computer and the computer power control device. As the computer is turned on/off, a signal is sent to the universal serial bus (USB) hub of the computer power control device through the signal cable. The signal activates a control circuit associated with the universal serial bus (USB) hub, which in turn disconnects the sockets other than the primary socket from an internal power inlet in the computer power control device. Instead, a mechanical power switch controls the connection of the primary socket to the power inlet. The separation of the primary socket from other sockets is realized by using a short N-shaped copper electrode plate and a long N-shaped copper electrode plate. When the computer is turned on, the short and long electrode plates are electrically connected, and hence all the sockets can supply power. On the other hand, if the computer is turned off, the short and long electrode plates are disconnected, and all the sockets except for the primary socket are disconnected from the power inlet. It is therefore an advantage that the turning on/off of a computer simultaneously switches on/off its peripheral devices, which can save time and electrical energy. It is a further advantage that the computer power control device according to the present invention is reliable and safe to use.

The present invention is thus described by the above embodiments. It will be obvious that the same invention may be varied in many ways. Such variations are not to be regarded as a departure from the spirit and scope of the present invention, and all such modifications as would be obvious to one skilled in the art are intended to be included within the scope of the following claims.

What is claimed is:

1. A computer power control device comprising
a jacket,
a power cord with one terminal connected to said jacket and the other terminal connected to a power plug that fits into an electrical outlet found in a particular geographic region,
a predetermined number of sockets in parallel connections on an upper portion of said jacket; one of said sockets being a primary socket, which is a power outlet for a computer; said sockets other than said primary socket being secondary sockets, which are power outlets for peripheral devices associated with said computer,
a power switch on said jacket,
a universal serial bus (USB) hub on said jacket connected to a universal serial bus (USB) port of said computer via a universal serial bus (USB) signal cable; and
said computer, when turned off, sending a signal to a control circuit within said jacket through said universal serial bus (USB) hub to disconnect said secondary sockets from a power inlet in said jacket, and therefore said secondary sockets no more functioning as power outlets; said computer, when turned on, sending a signal to a control circuit within said jacket through said universal serial bus (USB) hub to connect said secondary sockets to a power inlet in said jacket, and said secondary sockets being reactivated as power outlets.

2. The computer power control device of claim 1, wherein an RJ11 connector is installed on said jacket.

3. The computer power control device of claim 1, wherein an RJ45 connector is installed on said jacket.
